(19) United States
(12) Patent Application Publication
(10) Pub. No.: US 2013/0103430 A1
(43) Pub. Date: Apr. 25, 2013

(54) METHOD OF MANAGING AN INSURANCE SCHEME AND A SYSTEM THEREOF

(71) Applicants: Adrian Gore, Sandton (ZA); Barry Swartzberg, Sandton (ZA)

(72) Inventors: Adrian Gore, Sandton (ZA); Barry Swartzberg, Sandton (ZA)

(73) Assignee: DISCOVERY HOLDINGS LIMITED, Sandton (ZA)

(21) Appl. No.: 13/638,608

(22) PCT Filed: Mar. 29, 2011
(86) PCT No.: PCT/IB11/51333

§ 371 Date: Dec. 14, 2012

(30) Foreign Application Priority Data
Mar. 30, 2010 (ZA) 2010/02250

(51) Int. Cl. G06Q 40/08

(52) U.S. Cl. CPC G06Q 40/08
USPC 705/4

(57) ABSTRACT

A system and method for managing an insurance scheme including receiving data relating to homeowner behaviour. The data is analysed to determine the manner in which the homeowner has behaved for a past predetermined period and the analysed data is then used to determine one or more obligations of the homeowner to the insurer. The obligations may include the amount of a premium to be paid to the insurer for the insurance and/or the amount of the excess to be paid by the homeowner in the event of a claim to the insurer.

### BACKGROUND OF THE INVENTION

The present invention relates to a method of managing an insurance scheme and a system therefor, particularly an insurance scheme for household contents.

Various insurance schemes are known to insure household contents in the event of an accident or against theft, for example.

However, these insurance schemes do not take into account homeowner behaviour in any meaningful way when determining the obligations of the homeowner to the insurer. What is meant by obligations are for example the premium that is paid to the insurer and/or the excess that is paid by the homeowner in the event of an accident or theft.

The present invention seeks to address this.

### SUMMARY

According to one example embodiment there is provided a method of managing an insurance scheme, the method including:
obtaining data relating to homeowner behaviour;
analysing the data to determine the manner in which the homeowner has behaved for a past predetermined period; and
using the analysed data to determine one or more obligations of the homeowner to the insurer.

The one or more obligations of the homeowner to the insurer may include the amount of a premium to be paid to the insurer for the insurance of the house contents.

The one or more obligations of the homeowner to the insurer may include the amount of the excess to be paid by the homeowner in the event of a claim to the insurer.

The data received may include one or more of home safety checks data, inventory updating data and participation in community safety forums data.

The home safety checks data may include information relating to the security systems and access control to the home.

The inventory updating data includes information relating to the updating of the household inventory typically via an on-line facility.

The participation in community safety forums data includes information relating to the homeowners participation in various community safety forums.

The method may further include:
awarding points to the homeowner dependent on the home safety checks data, inventory updating data and participation in community safety forums data;
determining the total number of points awarded; and
determining the one or more obligations of the homeowner to the insurer wherein the higher the total number of points awarded the lower the one or more obligations of the homeowner to the insurer.

According to another example embodiment there is provided a system for managing an insurance scheme, the system including:
a receiving module to obtain data relating to homeowner behaviour;
an analysing module to analyse the data to determine the manner in which the homeowner has behaved for a past predetermined period; and
a calculation module to use the analysed data to determine one or more obligations of the homeowner to the insurer.

### BRIEF DESCRIPTION OF THE DRAWINGS

FIG. 1 illustrates an example system environment in which the present invention is implemented;

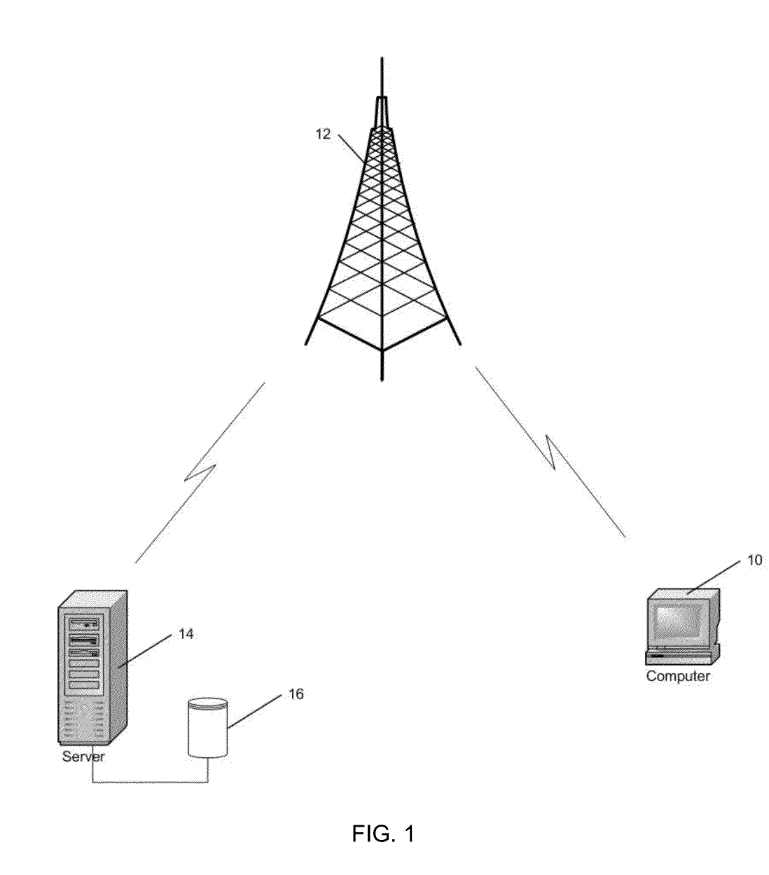

FIG. 2 is a block diagram illustrating an example system to implement the methodologies described herein; and

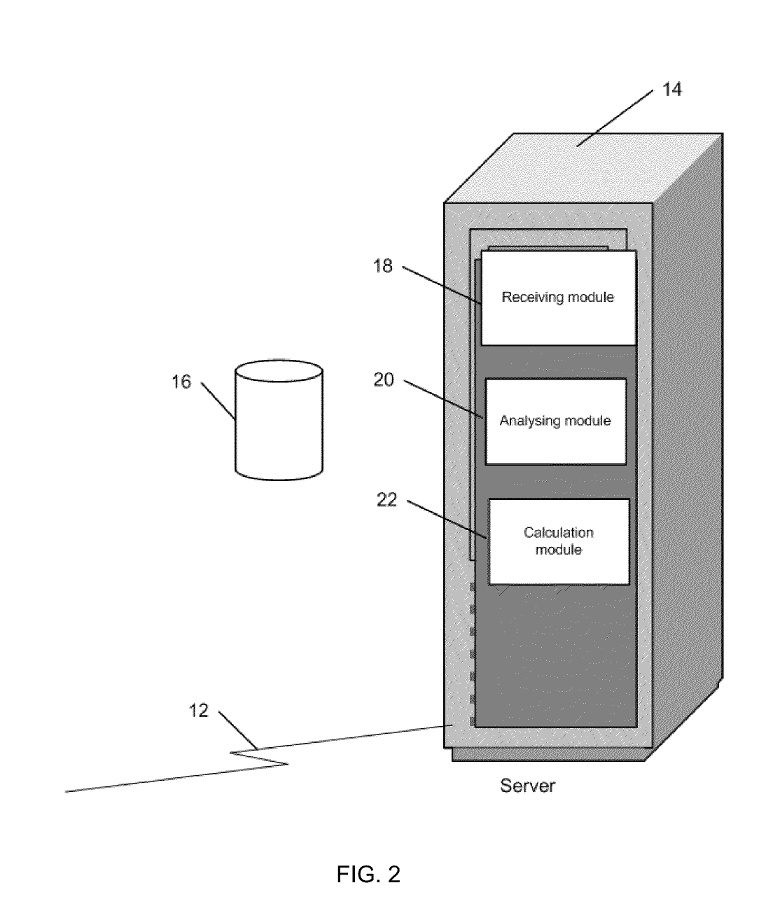

FIG. 3 is a block diagram illustrating an example embodiment method.

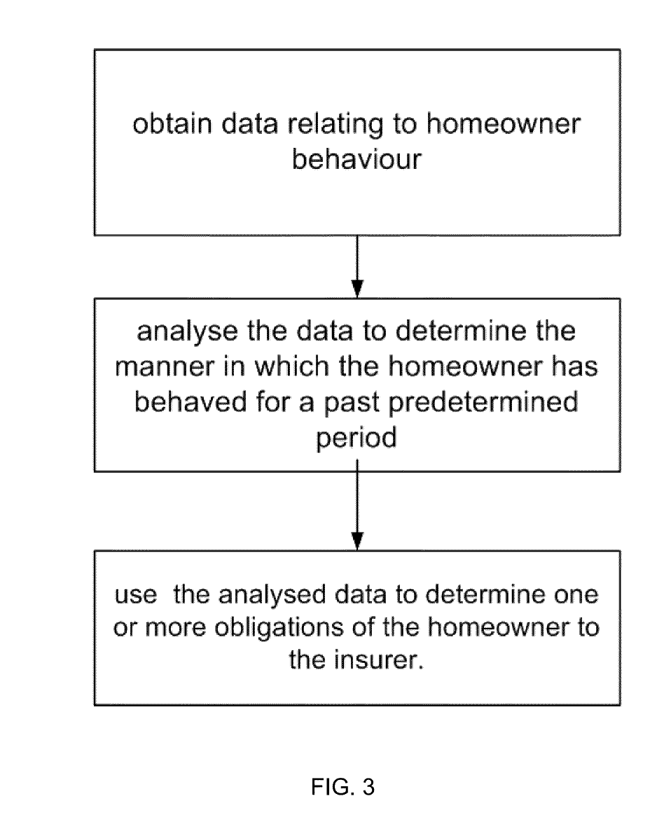

### DESCRIPTION OF EMBODIMENTS

The present invention relates to a method of managing an insurance scheme and a system therefor, particularly an insurance scheme for a house owner to insure the contents of their house.

For purposes of this document the terms home and house will be used interchangeably.

Various insurance schemes are known to insure the contents of a house in the event of an accident or against theft, for example. This type of insurance does not refer to the structure of the house but rather to the contents. It is therefore applicable to houses and flats or any other type of dwelling where the owner thereof wishes to insure the contents.

The contents of the house include any valuables such as cash, jewelry, art, electronic goods, furniture and clothes to name a few of very many examples.

These insurance schemes typically have the homeowner as the insured person that pays a premium to the insurer to insure the household contents against an insured event such as an accident or against theft, for example.

The quantum of the premium is usually determined using a number of factors such as the value of the contents.

An excess is also typically determined which is a first amount paid by the insured person in the event of a claim before the insurers pay towards the claim.

However, these insurance schemes do not take into account homeowner behaviour when determining the obligations of the homeowner to the insurer.

A system and method for addressing this is described below.

In one example embodiment, the system includes a number of modules which are described below. These modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

Referring to the accompanying drawings, data is received at a server 14 typically by a receiving module 18, the data containing information relating to homeowner behaviour.

The data is analysed by an analysing module 20 to determine the manner in which the homeowner has behaved for a past predetermined period and a calculation module 22 then uses the analysed data to determine one or more obligations of the homeowner to the insurer.

The one or more obligations of the homeowner to the insurer may include the amount of a premium to be paid to the insurer for the insurance of the house contents and/or the amount of the excess to be paid by the homeowner in the event of a claim to the insurer.

The data received at the server 14 includes one or more of home safety checks data, inventory updating data and participation in community safety forums data.

The home safety checks data typically includes information relating to the security systems and access control to the home. For example, a security systems check is done periodically which both assesses both physical barriers and alarm systems.

The physical barriers checked are items such as walls, fences, gates, safes, electric fencing.

The alarm systems check includes that the alarm is operating correctly and is linked to an armed response company.

The location of guard dogs on the property is also an issue that is assessed.

Furthermore, the staff working in the household, if any, are also subject to scrutiny.

The home safety checks data can be acquired in a number of different ways. Firstly, a consultant can be sent to the home to review the home safety. The consultant will capture the data either first on paper and later into a data capture device or straight into a portable data capture device.

This data can then be transmitted via a communications network 12 to the server 14.

Alternatively or in addition, the information can be entered by the homeowner into a computer 10 and then transmitted to the server 14 via the communications network 12.

In this embodiment, this would take the form of the homeowner accessing a questionnaire via the Internet and answering questions posed to the homeowner in the appropriate fashion. Thus the communications network 12 in this example is the Internet.

The staff working in the household, if any, are also subject to scrutiny by checking their backgrounds as well as the length of service of the staff and educating the staff regarding security matters.

In any event, the home safety checks data is typically stored in a memory such as in a database 16 associated with the server 14.

Inventory updating data is received by the server 14 including information relating to the updating of the household inventory.

This could also be accomplished using a consultant that is sent to the home to review the inventory that is being insured. The consultant will capture the inventory data either first on paper and later into a data capture device or straight into a portable data capture device.

In another embodiment, the homeowner updates the inventory typically via an on-line facility. Thus the homeowner uses computer 10 to access the Internet 12 and thereby upload the inventory information into the server 14.

The data is again stored in the database 16.

The participation in community safety forums data includes information relating to the homeowners participation in various community safety forums.

This information can also be obtained via an on-line questionnaire as described above or alternatively this information can be obtained from third parties such as directly from the community safety forums themselves.

This data is also stored in the database 16.

Once all of the data is obtained, the data is analysed by an analysing module 20.

The analysing module 20, in one example embodiment, allocates points to the homeowner based on the various types of data obtained and stored which describe the homeowner's behaviour.

In one example embodiment, the data is analysed by the analysing module 22 and points are awarded to each of a number of sub-categories. It will be appreciated that the scoring could be arranged that a higher score is a successful score or that a lower score is a successful score. In the illustrated embodiments described below a higher score will be deemed a better score than a lower score.

One example of how this could be implemented is as follows:

| | max |
|---|---|
| Claim behaviour points | 25 |
| Number of claims last 3 years | |
| >=4 or not | −30 |
| previously insured | |
| 3 | −10 |
| 2 | 0 |
| 1 | 15 |
| 0 | 25 |
| | max |
| Pro-active points | 45 |
| Technical home safety check | 15 |
| every 12 months through | |
| accredited partner | |
| No check in 24 months | −15 |
| Update inventory every 12 months | 15 |
| No update in 24 months | −15 |
| Completion of Home Safety and | 15 |
| Security Mindfulness | |
| questionnaire on website | |
| Questionnaire not completed in | −15 |
| last 24 months | |
| | max |
| Policy management points | 30 |
| No premium payments skipped | 12 |
| POLICYHOLDER | 100 |
| RESPONSIBILITY SCORE | |

In the above example, the extra categories of “policy management points” and “claim behaviour points” have been added to give an overall score. However, it will be appreciated that the middle category referred to as “pro-active points” described in detail above could be implemented alone or could be implemented with one or both of the other categories.

In this example, it will be appreciated that if the homeowner complies with the programme they will earn an increasing number of points up to a maximum of 100 points.

This is then used by the calculation module 22.

In one example, the premium that the homeowner pays to the insurer is altered by a percentage, which percentage is related to the amount points wherein the higher the amount of points the higher the percentage.

It will be appreciated that other methods of using the points to calculate the premium could be used such as only giving a discount for relatively higher point scores to name one example.

In addition the amount of the excess could be adjusted depending on the number of points whereby the higher the number of points the lower the excess amount.

Thus it will be appreciated that the present invention provides a method of determining the obligations of the homeowner to the insurer in a much more intelligent manner that encourages the homeowner to improve their behaviour and thereby reduce their risk. This in turn reduces the risk of a claim to the insurer and is therefore beneficial to all parties.

1-18. (canceled)

19. A method of managing an insurance scheme, the method including:
receiving, by a computer, data relating to homeowner behaviour;
analysing the data with the computer to determine the manner in which the homeowner has behaved for a past predetermined period; and
using the analysed data with the computer to determine one or more obligations of the homeowner to the insurer.

20. The method according to claim 19 wherein the one or more obligations of the homeowner to the insurer includes the amount of a premium to be paid to the insurer for the insurance of the house contents.

21. The method according to claim 19 wherein the one or more obligations of the homeowner to the insurer includes the amount of an excess to be paid by the homeowner in the event of a claim to the insurer.

22. The method according to claim 19 wherein the data received includes one or more of home safety checks data, inventory updating data and participation in community safety forums data.

23. The method according to claim 22 wherein the home safety checks data includes information relating to the security systems and access control to the home.

24. The method according to claim 22 wherein the inventory updating data includes information relating to the updating of the household inventory.

25. The method according to claim 24 wherein the updating of the household inventory is done via an on-line facility.

26. The method according to claim 22 wherein the participation in community safety forums data includes information relating to the homeowner's participation in various community safety forums.

27. The method according to claim 19 further including:
awarding points to the homeowner dependent on the home safety checks data, inventory updating data and participation in community safety forums data;
determining the total number of points awarded; and
determining the one or more obligations of the homeowner to the insurer wherein the higher the total number of points awarded the lower the one or more obligations of the homeowner to the insurer.

28. A computer system for managing an insurance scheme, the system including:
a receiving module to obtain data relating to homeowner behaviour;
an analysing module to analyse the data to determine the manner in which the homeowner has behaved for a past predetermined period; and
a calculation module to use the analysed data to determine one or more obligations of the homeowner to the insurer.

29. The computer system according to claim 28 wherein the one or more obligations of the homeowner to the insurer includes the amount of a premium to be paid to the insurer for the insurance of the house contents.

30. The computer system according to claim 28 wherein the one or more obligations of the homeowner to the insurer includes the amount of an excess to be paid by the homeowner in the event of a claim to the insurer.

31. The computer system according to claim 28 wherein the receiving module receives data including one or more of home safety checks data, inventory updating data and participation in community safety forums data.

32. The computer system according to claim 31 wherein the home safety checks data includes information relating to the security systems and access control to the home.

33. The computer system according to claim 31 wherein the inventory updating data includes information relating to the updating of the household inventory.

34. The computer system according to claim 33 wherein the receiving module receives updating of the household inventory via an on-line facility.

35. The computer system according to claim 31 wherein the participation in community safety forums data includes information relating to the homeowner's participation in various community safety forums.

36. The computer system according to claim 31 wherein:
the analysing module further award points to the homeowner dependent on the home safety checks data, inventory updating data and participation in community safety forums data and determine the total number of points awarded; and
the calculation module determines the one or more obligations of the homeowner to the insurer wherein the higher the total number of points awarded the lower the one or more obligations of the homeowner to the insurer.
